(19) United States
(12) Patent Application Publication
(10) Pub. No.: US 2007/0052640 A1
(43) Pub. Date: Mar. 8, 2007

(54) Field sequential LCD display system

(76) Inventor: Bernard Feldman, Watsonville, CA (US)

Correspondence Address: DAVIDSON BERQUIST JACKSON & GOWDEY LLP, 4300 WILSON BLVD., 7TH FLOOR, ARLINGTON, VA, 22203, US

(21) Appl. No.: 11/220,674

(22) Filed: Sep. 8, 2005

(51) Int. Cl. G09G 3/36

(52) U.S. Cl. 345/88

(57) ABSTRACT

A method and system for compensating for the response characteristics of a display using field sequential addressing and pre-processing. Utilizing a display with multiple backlights of various colors, each pixel of the display can be represented with a single LCD element. By examining the changes in the intensity of the fields (e.g., red, green and blue) on a pixel-by-pixel basis for respective fields as the frames change, and before the pixels are displayed, the signal used to drive the LCD element can be compensated to adjust for display properties (e.g., the slowness of a display that might otherwise cause artifacts).

### BACKGROUND OF THE INVENTION

1. Field of the Invention

The present invention is directed to a multi-field method and system for correcting color fields in a display device, and in one embodiment to a field sequential LCD-based display system.

2. Discussion of the Background

Liquid Crystal Displays (LCDs) for color applications conventionally utilize a trio of sub-pixels, red, green, blue (RGB) which are independently excited and small enough to blend together in the naked eye of the viewer. Data comprising the images are generally (and in the case of TV specifically) transmitted at the rate of 60 Hertz (Hz.). Thus, each frame is presented every 16.67 milliseconds (ms.). Each frame comprises the totality of picture elements (pixels) in the frame. For color applications there are three sub-pixels for every pixel. The number of pixels per frame is determined by the resolution of the image. The resolution is determined by the number of rows and columns in the matrix of image elements. Typical resolutions employed for displays are designated by convention as follow:
VGA=640×480=307,200 pixels=921,000 sub-pixels.
XGA=1024×628=786,432 pixels=2,359,296 sub-pixels
WXGA=1366×768=1,049,088 pixels=3,147,264 sub-pixels
SXGA=1280×1024=1,310,720 pixels=3,932,160 sub-pixels

In active matrix LCDs (AMLCDs), a thin film transistor (TFT) has traditionally been required for every sub-pixel. AMLCDs utilize a backlight to illuminate the display and a color filter aligned precisely to the respective color sub-pixels. The image is formed by the voltage control of the orientation of the LC molecules associated with each sub-pixel. This control involves the use of cross-polarizers in such manner that in addition to the on-off valve effect of the LC molecule, gray scale is a also achieved by intermediate orientations of the LC molecules. FIG. 1A illustrates a portion of a AMLCD utilizing three-TFTs per pixel. FIG. 1B illustrates the portion of the AMLCD of FIG. 1A with six TFTs illuminated in a frame

In the late forties, CBS Laboratories used a wheel of color filters in front of the CRT and rotating in synchronism with the sequence of color frames on a black and white TV. This approach lost out to the RCA achievement of depositing color phosphor dots on the internal face of the TV screen, which worked and was free of the whirling noise of the CBS method.

U.S. Pat. No. 5,337,068 (to Stewart, et al., and incorporated herein by reference) discloses utilizing switched color fluorescent interleaved backlights. It points out that other backlights, cathodoluminescent and electroluminescent sources match the switching speed requirements. However, the system relies on the availability of a fast enough response time LC material to avoid motion artifacts (blur) in video images. This time is sometimes specified as 5.5 ms; however, as subsequently revealed 4.4 ms. is a more accurate requirement. One specified design factor is a 4-micron cell gap for plates of the LCD.

U.S. Pat. No. 6,557,063 (to Okita, and incorporated herein by reference) reduces the cell gap to 2 microns, which reduces the response time by a factor of four over conventional 4-micron technology. Okita also heats the display to reduce response time by lowering the viscosity of the LC material. In order to achieve a response time of 5.5 ms, a third technique of switching the back-light on and off is also used. The backlight is switched off for a portion of the 5.5 ms period and while it is off a voltage is applied which orients the LC molecules to the black state. In this way, the longer response time associated with a gray-to-gray transition is reduced. However, this structure requires a cell gap that is difficult and expensive to achieve, especially for large TV displays, and heating the display is potentially disadvantageous.

Various other techniques have been proposed to address the driving of displays. For example, (1) K. Nakanishi, et al., “Fast Response 15-1n. XGA TFT-LCD with Feedforward Driving (FFD) Technology for Multimedia Applications”, SID 2001 DIGEST, pp. 488-491; (2) Richard I. McCartney, “A Liquid Crystal Display Response Time Compensation Feature Integrated into an LCD Panel Timing Controller”, SID DIGEST 2003, pp. 1350-1353; (3) Kazuo Sekiya and Hajime Nakamura, “Overdrive Method for TN-mode LCDs-Recursive System with Capacitance Prediction”, SID DIGEST, 2001, pp. 114-117; (4) K. Kawabe and T. Furuhashi, “New TFT-LCD Driving Method for Improved Moving Picture Quality”, SID DIGEST, 2001, pp. 998-1001; (5) Baek-woon Lee, et. al., ‘Reducing Gray-level Response to one frame: Dynamic Capacitance Compensation”, SID DIGEST 2001, pp. 1260-1263; (6) Haruhiko Okumura, et. al., “Advanced Level Adaptive Overdrive (ALAO) Method Applicable to Full HD-LCTVs”, SID DIGEST, 2002, pp. 68-71; (7) Seung-Woo Lee, et. al., “Improved Technology for Motion Artifact Elimination in LCD Monitors: Advanced DCC”, SID DIGEST, 2005, pp 1496-1499; and (8) H. Nakamura, et. al., “A Novel Wide-Viewing-Angle Motion-Picture LCD”, SID DIGEST, 1998, pp. 143-146. The contents of those references are incorporated herein by reference in their entirety.

### SUMMARY OF THE INVENTION

The present invention utilizes pre-processing of fields (i.e., the red field, the blue field and the green field), on a field-by-field basis, to improve the appearance of a display (e.g., a AMLCD).

### BRIEF DESCRIPTION OF THE DRAWINGS

FIG. 1A is a portion of an AMLCD utilizing three-TFTs per pixel.

FIG. 1B illustrates the portion of the AMLCD of FIG. 1A with six TFTs illuminated in a frame.

FIG. 2A is a portion of an AMLCD according to the present invention which includes a red back-light behind the pixel elements.

FIG. 2B illustrates the portion of the AMLCD of FIG. 2A with only two TFTs allowing red light to pass from the red back-light through to the user.

FIG. 3A is the portion of an AMLCD of FIG. 2A which also includes a green back-light behind the pixel elements.

FIG. 3B illustrates the portion of the AMLCD of FIG. 3A with only two TFTs allowing green light to pass from the green back-light through to the user.

FIG. 4A is the portion of an AMLCD of FIG. 2A which also includes a blue back-light behind the pixel elements.

FIG. 4B illustrates the portion of the AMLCD of FIG. 4A with only two TFTs allowing blue light to pass from the blue back-light through to the user.

FIG. 5 illustrates a single circuit performing the field-by-field compensation of video data for all the fields of plural frames of data.

FIG. 6 illustrates parallel circuits performing field-specific compensation of video data for their respective fields of plural frames of data.

FIG. 7 illustrates parallel circuits performing field-specific compensation of video data for their respective fields of plural frames of data and for respective levels.

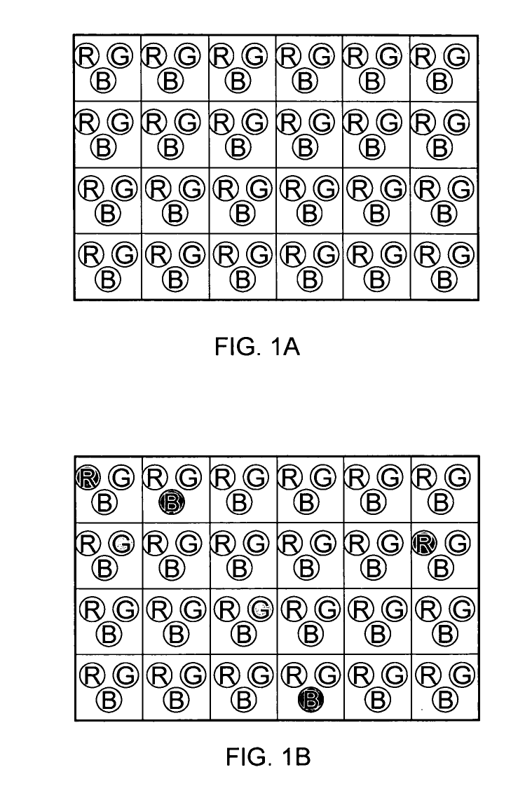

### DETAILED DESCRIPTION OF THE INVENTION

U.S. Pat. No. 5,844,534 (to the present inventor, Feldman) describes pre-processing pixel information prior to display of the corresponding pixels. Pre-processing can be pixel-by-pixel, for less than one frame, one frame at a time, or for plural frames. However, the technique of the '534 patent can be combined with the structure described below for even further improvements. The contents of the '534 patent are incorporated herein by reference.

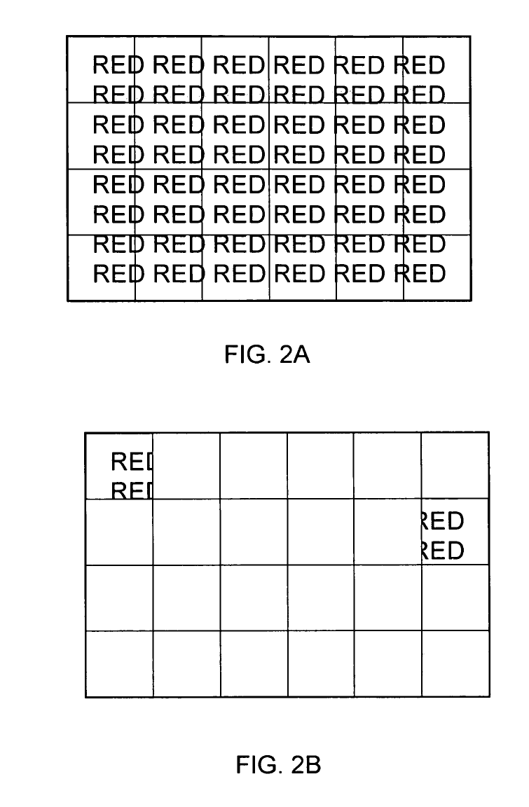

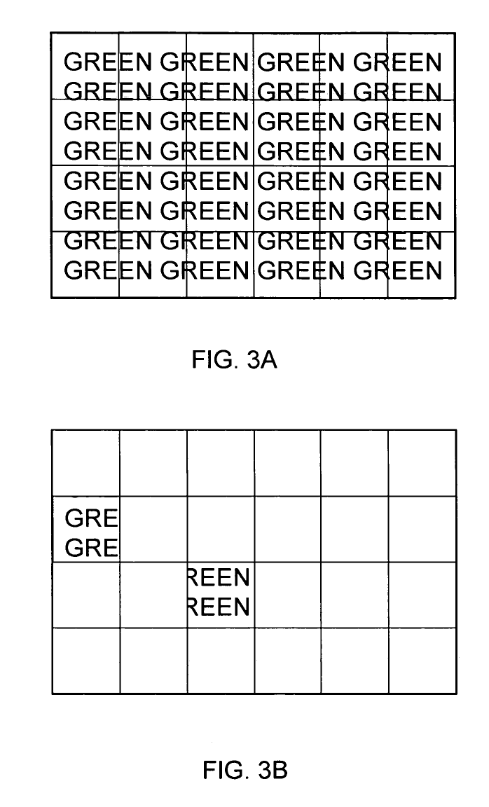

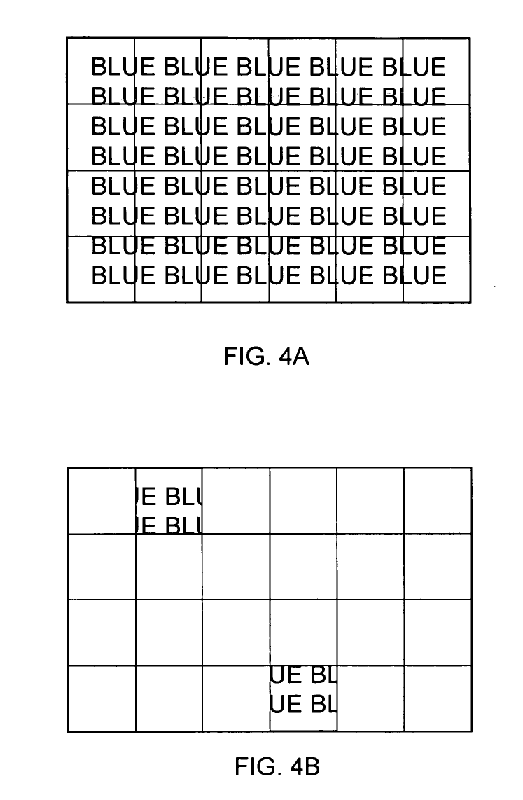

According to the present invention, rather than utilizing separate red, blue and green sub-pixel elements per pixel, each pixel is represented by a single thin film transistor element which is used in conjunction with red, blue and green back-lights, as is illustrated in FIGS. 2A, 3A and 4A. Those back-lights are switched on and off in synchronism with the corresponding color image data for each frame, as shown in FIGS. 2B, 3B and 4B. In conjunction with that structure, specialized addressing termed “Field Sequential Addressing (FSA)” is utilized in order to achieve one or more of the following benefits:
1. Pixel count and TFTs are reduced by a factor of three.
2. The required number of drivers is cut by a factor of three.
3. Elimination of the need for a color filter and consequent increase in brightness and reduced power consumption.
4. The potential for higher resolution increases.
5. Display yield improves.
6. Display cost is reduced.

According to the present invention, data for a display frame is stored in a computer memory, the pixel data is then analyzed on a per-pixel basis, and the presentation to the viewer is delayed long enough so that stored frame data can be potentially modified or adjustment values calculated which potentially alter how the display is driven for a future frame. This process is practicable for displays due to the time elements involved. The delay time is short enough to be undetectable by the viewer and digital computers are fast enough to accomplish the required analysis and apply corrective action to the delayed frame on a pixel-by-pixel basis. According to the present invention, this technique can been applied to the process of correcting motion artifacts for video presentations of LCDs.

All transitions from pixel-to-pixel can be described as gray-to-gray transitions, black and white being simply two sub-categories of gray-to-gray transitions. Proper image reproduction requires gray-to-gray representations. Due to the sluggishness of the LCD molecule and the voltage needed to make a change in its orientation, nearby gray-to-gray transitions are slower than those that are farther apart (in the extreme, black-to-white and vice versa). Consequently, a commonly employed technique for reducing motion picture response times (MPRTs) is called “Black light blinking. In a blinking black light configuration, between each field, the LCD molecular alignments are reset to zero transmission (or black). This temporarily blocks the transmission of the backlight, but the user is unaware of the blinking. Black is selected for the reference since black-to-gray transitions are faster than white-to-grays. Overall the MPRTs are faster using this technique. The technique can be employed for FSA applications. However, as can be seen from the following look-ahead procedure, black light blinking may not be required since the gray level of any pixel in one color is unrelated to the gray level of the same pixel in another color. Overall this may bring about faster MPRTs without the use of blinking backlights. All modes of LCD alignment and organization, such as Twisted Nematic (TN), In Plane Switching (IPS), Multi-domain Vertical Alignment (MVA), Patterned Vertical Alignment (PVA) and Optically Compensated Bend (OCB) face similar blurring problems. Whatever method is used for reducing MPRTs, it should be noted that the reduction in response time achieved by looking ahead one frame can be further reduced by looking ahead plural frames in order to apply more refined and effective corrections. The object of this plural methodology is to apply as many look-ahead cycles, n, as is required to achieve an MPRT of less than 4.4 ms. so that field sequential addressing can be successfully employed.

When employing field sequential addressing a different look-ahead procedure is required. Let the current frame for each of the colors be designated as follows:
^{r}I₁, ^{b}I₁, ^{g}I₁ (r, b & g representing the red, blue and green color data for the I₁th frame).

Then the procedure looks ahead plural frames for data to be analyzed and a correction applied to the I₁th frame. Data is recorded for n sequential frames as follows:
^{r}I₁, ^{b}I₁, ^{g}I₁, ^{r}I₂, ^{b}I₂, ^{g}I₂, . . . ^{r}Iₙ, ^{b}Iₙ, ^{g}Iₙ.
   The r,b,g sequence is arbitrary; any other order of the colors is equivalent

The correction applied to the ^{r}I₁ frame is determined by analysis of the data from the ^{r}I₂ . . . ^{r}Iₙ frames. The correction applied to the ^{b}I₁ frame is applied from the analysis of the data from the ^{b}I₂ . . . ^{b}Iₙ, frames. The correction applied to the ^{g}I₁ frame is applied from analysis of the data from the ^{g}I₂ . . . ^{g}Iₙ frames.

It is to be noted that the same amount of memory space is required to accomplish the same degree of correction as for parallel presentation of the corrected voltages to the red, blue and green subpixels. Since the presentation speed is three times as fast the delay time is also the same. It is also observed that the fact that data is recorded sequentially results in gray-to-gray transitions from one color to another.

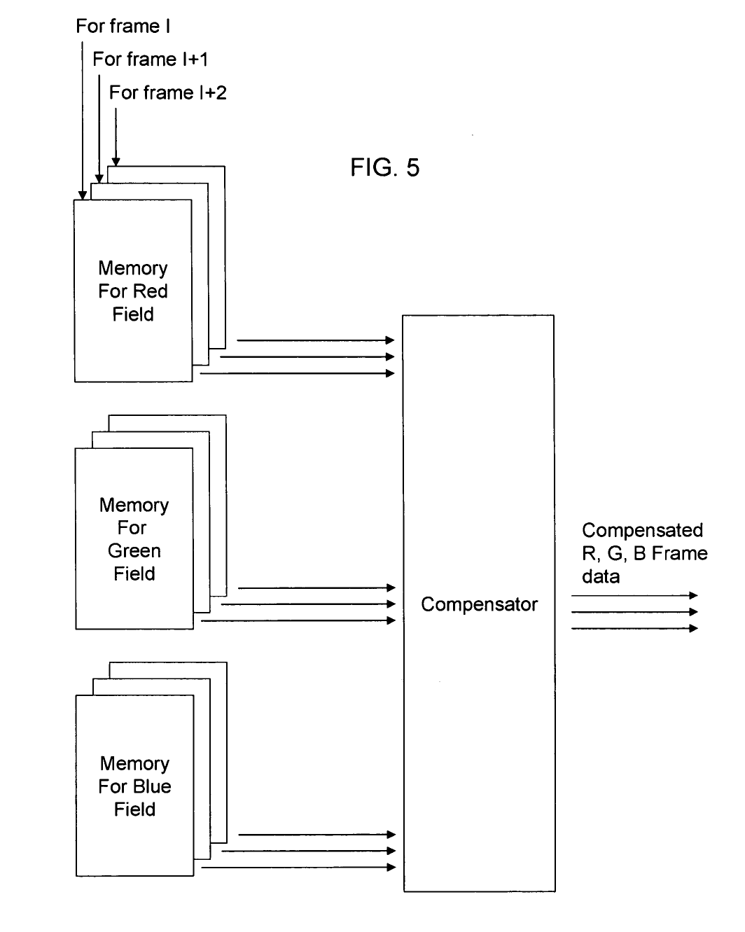

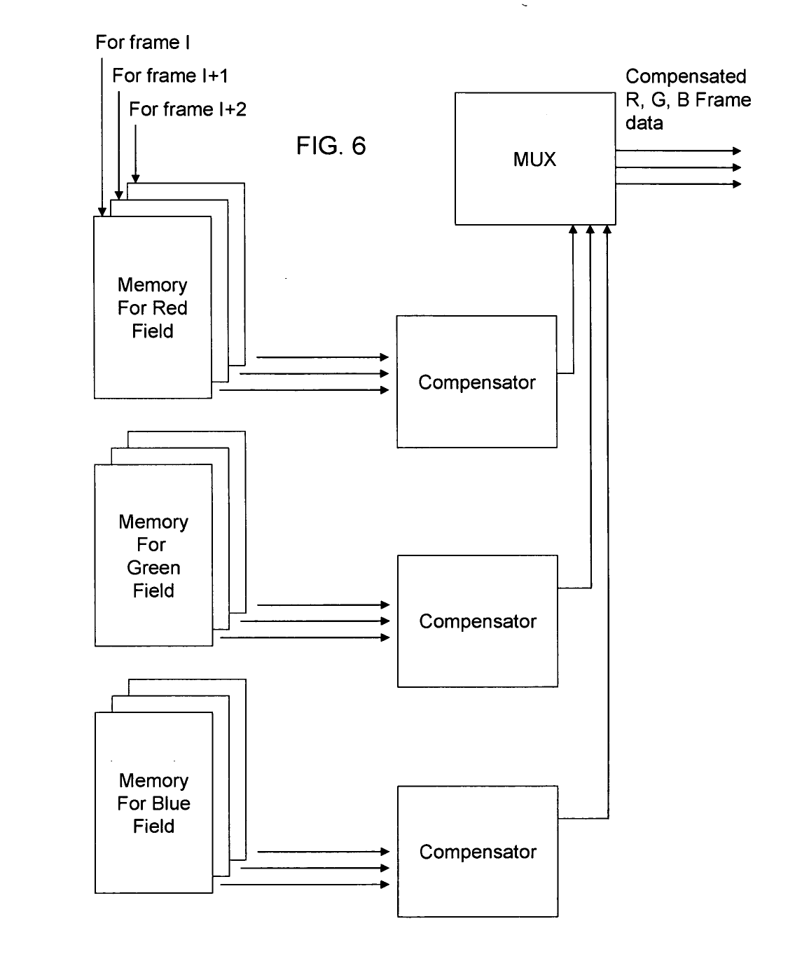

In one embodiment of the present invention, a single circuit performs compensation for each of the fields of the video data, on a field-by-field basis, as shown in FIG. 5. In an alternate embodiment, shown in FIG. 6, plural circuits work in parallel to perform compensation for respective fields of the video data.

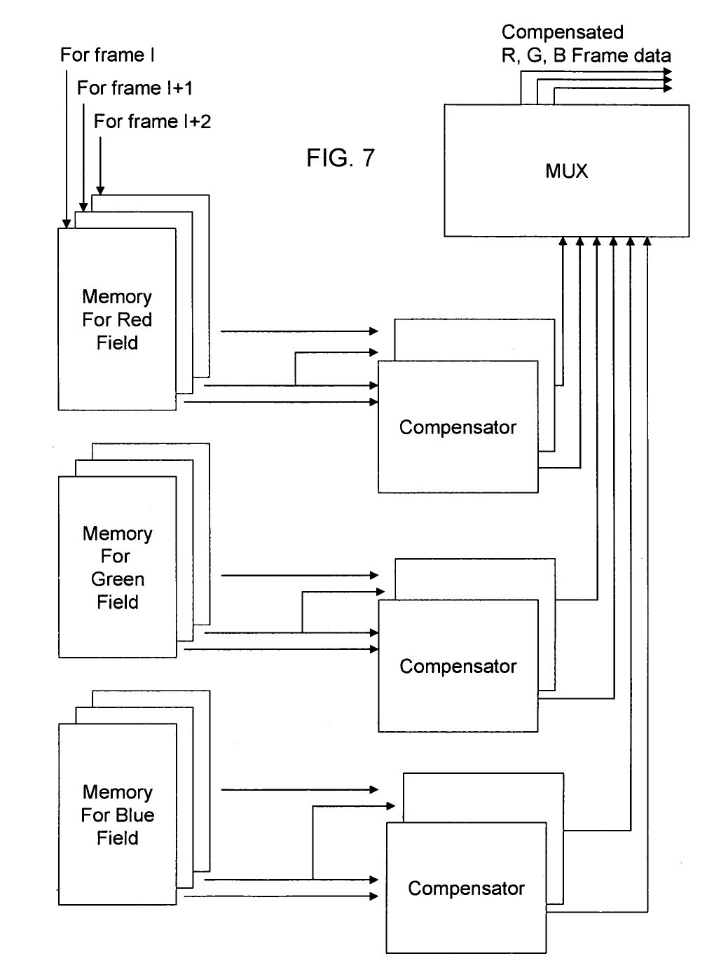

The present invention is also not restricted to performing compensation using only two frames at a time. In one embodiment of the present invention, at least three frames of data are compared on a field-by-field basis. In one such embodiment, a single circuit repetitively performs the compensation of fields of frames Ii, Iᵢ₊₁ and Iᵢ₊₂, as shown in FIG. 5. In an alternate embodiment, plural circuits each perform their corresponding levels of compensation, e.g., a circuit at one level performing compensation for fields of frames Ii and Iᵢ₊₁, and a circuit at another level performing compensation for fields of frames Iᵢ₊₁ and Iᵢ₊₂. Moreover, a multi-parallel implementation includes plural circuits working in parallel for each field and plural circuits working in parallel for each level, as shown in FIG. 7.

The compensation circuit can be implemented using a number of different techniques. One such technique is a lookup table having the dimension of the number of frames being used. When using two frames, a color value of a pixel of a first frame and a color value of a pixel of a second frame are used as first and second indices into the lookup table. If, for example, there were 256 possible values for each color, then the table would be 256 by 256, and the value stored in the table would be the corrected value for that pair of indices. In an embodiment where the compensations are symmetric (i.e., table(i,j)=table(j,i) for all i and j, where i and j are the indices for the table), the size of the table can be reduced.

In an embodiment where the compensations are not symmetric, the system may take advantage of transitions that are easier in one direction than the other, if they exist. For example, if less of a correction is needed going from 20 to 60 than from 60 to 20, then the correction value in the lookup table for table(20,60) would not be the same as the correction value in the lookup table for table(60,20).

The various fields may either share a single lookup table or may include field-specific lookup tables.

In yet another embodiment, the compensation may be a simple averaging circuit that averages the pixel values over the number of frames included in the compensation.

This invention has been described in relation to AMLCD applications but the spirit of the invention applies to other non-emissive displays that currently exist or may be developed in the future.

The present invention may be achieved using hardware or a combination of hardware and software. As such, embodiments including ASICs, FPGAs, and embedded processors and general purpose processors are all included within the scope of the term “circuit” as used herein.

1. In a display driving circuit, the improvement comprising:
a memory for holding a plurality of frames of video data, each frame comprising red, green and blue fields of video data;
a compensator for compensating, on a frame-by-frame basis, (1) video data from a first field of the red, green and blue fields of video data from a first frame of the plurality of frames of video data using (2) video data from the first field of the red, green and blue fields of video data from a second frame of the plurality of frames of video data; and
a driver for driving the compensated video data from the first field of the red, green and blue fields of video data from the first frame of the plurality of frames of video data after compensation by the compensator.

2. The display driving circuit as claimed in claim 1, wherein the compensator further comprises circuitry for compensating on a frame-by-frame basis, (1) video data from a second field of the red, green and blue fields of video data from the first frame of the plurality of frames of video data using (2) video data from; the second field of the red, green and blue fields of video data from the second frame of the plurality of frames of video data; and
wherein the driver is further configured to drive the compensated video data form the second field of the red, green and blue fields of video data from the first frame of the plurality of frames of video data after compensation by the compensator.

3. The display driving circuit as claimed in claim 2, wherein the compensator further comprises circuitry for compensating, on a frame-by-frame basis, (1) video data from a third field of the red, green and blue fields of video data from the first frame of the plurality of frames of video data using (2) video data from the third field of the red, green and blue fields of video data from the second frame of the plurality of frames of video data; and
wherein the driver is further configured to drive the compensated video data from the third field of the red, green and blue fields of video data from the first frame of the plurality of frames of video data after compensation by the compensator.

4. The display driving circuit as claimed in claim 2, wherein compensator compensates the video data from the first field of the red, green and blue fields of video data from the first frame of the plurality of frames of video data in parallel with the video data from the second field of the red, green and blue fields of video data from the first frame of the plurality of frames of video data.

5. The display driving circuit as claimed in claim 3, wherein compensator compensates the video data from the fist field of the red, green and blue fields of video data from the first frame of the plurality of frames of video data in parallel with the video data from the second field of the red, green and blue fields of video data form the first frame of the plurality of frames of video data and the video data from the third field of the red, green and blue fields of video data from the first frame of the plurality of frames of video data.

6. The display driving circuit as claimed in claim 1, wherein the memory for holding a plurality of frames of video data holds at least tree frames of video data, each frame comprising red, green and blue fields of video data.

7. The display driving circuit as claimed in claim 1, further comprising circuitry for resetting LCDs driven by the driver to zero transmission after each field is displayed.

8. In a display driving method, the improvement comprising:
storing a plurality of frames of video data in at least one memory, each frame comprising red, green and blue fields of video data;
compensating on a frame-by-fame basis, (1) video data from a first field of the red, green and blue fields of video data from a first frame of the plurality of frames of video data using (2) video data from the first field of the red, green and blue fields of video data from a second frame of the plurality of frames of video data; and
driving the compensated video data from the first field of the red, green and blue fields of video data from the first frame of the plurality of frames of video data after compensation.

9. The display driving method as claimed in claim 8, further comprising:
compensating, on a frame-by-fame basis, (1) video data from a second field of the red, green and blue fields of video data from the first frame of the plurality of frames of video data using (2) video data from the second field of the red, green and blue fields of video data from the second frame of the plurality of frames of video data; and
driving the compensated video data from the second field of the red, green and blue fields of video data from the first frame of the plurality of frames of video data after compensation.

10. The display driving method as claimed in claim 9, further comprising:
compensating, on a frame-by-frame basis, (1) video data from a third field of the red, green and blue fields of video data from the first frame of the plurality of frames of video data using (2) video data from the third field of the red, green and blue fields of video data from the second frame of the plurality of frames of video data; and
driving the compensated video data from the third field of the red, green and blue fields of video data from the first frame of the plurality of frames of video data after compensation.

11. The display driving method as claimed in claim 9, wherein compensating the video data from the first field of the red, green and blue fields of video data from the first frame of the plurality of frames of video data occurs in parallel with compensating the video data from the second field of the red, green and blue fields of video data from the first frame of the plurality of frames of video data.

12. The display driving method as claimed in claim 11, wherein compensating the video data from the first field of the red, green and blue fields of video data from the first frame of the plurality of frames of video data occurs in parallel with compensating the video data from the second field of the red, green and blue fields of video data from the first frame of the plurality of frames of video data and compensating the video data from the field of the red, green and blue fields of video data from the first frame of the plurality of frames of video data.

13. The display driving method as; claimed in claim 8, wherein the storing comprises storing at least three frames of video data, each frame comprising red, green and blue fields of video data.

14. The display driving method as claimed in claim 8, further comprising resetting LCDs driven by the driving step to zero transmission after each field is displayed.

15. A display comprising:
a screen;
a memory for holding a plurality of frames of video data, each frame comprising red, green and blue fields of video data;
a compensator for compensating, on a frame-by-frame basis (1) video data from a first field of the red, green and blue fields of video data from a first frame of the plurality of frames of video data using (2) video data from the first field of the red, green and blue fields of video data from a second frame of the plurality of frames of video data; and
a driver for sending to the screen the compensated video data from the first field of the red, green and blue fields of video data from the first frame of the plurality of frames of video data after compensation by the compensator.

16. The display as claimed in claim 15, wherein the screen comprises a television screen.

17. The display as claimed in claim 16, wherein the screen comprises a computer monitor.

18. The display as claimed in claim 15, where in the screen comprises an active matrix LCD display.

19. The display driving circuit as claimed in claim 8, further comprising:
red, green and blue backlights for sequentially illuminating pixels driven by the driver, wherein all pixels of a field are driven simultaneously and wherein each pixel is represented by a single thin film transistor element shared between the red, green and blue backlights.

20. The display driving method as claimed in claim 8, wherein the driving step comprises illuminating red, green and blue backlights for sequentially illuminating pixels, wherein all pixels of a field are driven simultaneously and wherein each pixel is represented by a single thin film transistor element shared between the red, green and blue backlights.

21. The display as claimed in claim 15, further comprising:
red, green and blue backlights for sequentially illuminating pixels driven by the driver, wherein all pixels of a field are driven simultaneously and wherein each pixel is represented by a single thin film transistor element shared between the red, green and blue backlights.
